(19) United States
(12) Patent Application Publication
(10) Pub. No.: US 2015/0078655 A1
(43) Pub. Date: Mar. 19, 2015

(54) DEVICES, SYSTEMS, AND METHODS FOR LARGE-SCALE LINEAR DISCRIMINANT ANALYSIS OF IMAGES

(71) Applicant: CANON KABUSHIKI KAISHA, Tokyo (JP)

(72) Inventors: Juwei Lu, Oakville (CA); Bradley Scott Denney, Irvine, CA (US); Hung Khei Huang, Irvine, CA (US)

(73) Assignee: CANON KABUSHIKI KAISHA, Tokyo (JP)

(21) Appl. No.: 14/030,861

(22) Filed: Sep. 18, 2013

(51) Int. Cl. G06K 9/62

(52) U.S. Cl. CPC G06K 9/6256
USPC 382/159

(57) ABSTRACT

Systems, devices, and methods for generating hierarchical subspace maps obtain a training set of images, wherein the images in the training set of images are each associated with at least one category in a plurality of categories; organize the images in the training set of images into a category hierarchy based on the training set of images and on the plurality of categories, wherein the category hierarchy identifies each of the categories in the plurality of categories as at least one of a parent category and child category; and generate a subspace map for each parent category based on images associated with respective child categories of the parent category, thereby generating a plurality of subspace maps.

### BACKGROUND

1. Technical Field

This description generally relates to visual analysis of images.

2. Background

In the field of image analysis, images are often converted to representations. A representation is often more compact than an image, and comparing representations is often easier than comparing images. Representations can describe various image features, for example scale-invariant feature-transform (SIFT) features, speeded-up robust (SURF) features, local binary patterns (LBP), color histograms (GIST), and histogram-of-oriented-gradients (HOG) features. Representations include Fisher vectors and bag-of-visual features (BOV). However they often produce a very high-dimensional image representation, which makes the image representation difficult to both store and search.

### SUMMARY

In one embodiment a method comprises obtaining a training set of images, wherein the images in the training set of images are each associated with at least one category in a plurality of categories; organizing the images in a training set of images into a category hierarchy based on the training set of images and on the plurality of categories, wherein the category hierarchy identifies each of the categories in the plurality of categories as at least one of a parent category and child category; and generating a subspace map for each parent category based on images associated with respective child categories of the parent category, thereby generating a plurality of subspace maps.

In one embodiment, a computing device comprises one or more computer-readable media and one or more processors coupled to the computer-readable media and configured to cause the computing device to perform operations including obtaining a training set of images; assigning the images to a category in a category hierarchy, wherein the category hierarchy identifies each of the categories in the plurality of categories as at least one of a parent category and child category; and generating a subspace map for each parent category based on images assigned to respective child categories of the parent category, thereby generating a plurality of subspace maps.

In one embodiment, one or more computer-readable media store instructions that, when executed by one or more computing devices, cause the computer devices to perform operations comprising obtaining a training set of images; assigning the images to a category in a category hierarchy, wherein the category hierarchy identifies each of the categories in the plurality of categories as at least one of a parent category and child category; and generating a subspace map for each parent category based on images assigned to respective child categories of the parent category, thereby generating a plurality of subspace maps.

### BRIEF DESCRIPTION OF THE DRAWINGS

FIG. 1 illustrates an example embodiment of the generation of hierarchical subspace maps.

FIG. 2 illustrates an example embodiment of a method for generating hierarchical subspace maps.

FIG. 3 illustrates an example embodiment of a method for generating hierarchical subspace maps.

FIG. 4 illustrates an example embodiment of a flow of operations for generating a subspace map for a category.

FIG. 5 illustrates an example embodiment of a method for generating a category hierarchy.

FIG. 6 illustrates an example embodiment of a category hierarchy.

FIG. 7 illustrates an example embodiment of a method for generating hierarchical subspace maps.

FIG. 8 illustrates an embodiment of the encoding of an image based on category subspace maps.

FIG. 9 illustrates an example embodiment of a system for generating subspace maps.

FIG. 10A illustrates an example embodiment of a system for generating subspace maps.

FIG. 10B illustrates an example embodiment of a system for generating subspace maps.

### DESCRIPTION

The following disclosure describes certain explanatory embodiments. Other embodiments may include alternatives, equivalents, and modifications. Additionally, the explanatory embodiments may include several novel features, and a particular feature may not be essential to some embodiments of the devices, systems, and methods described herein.

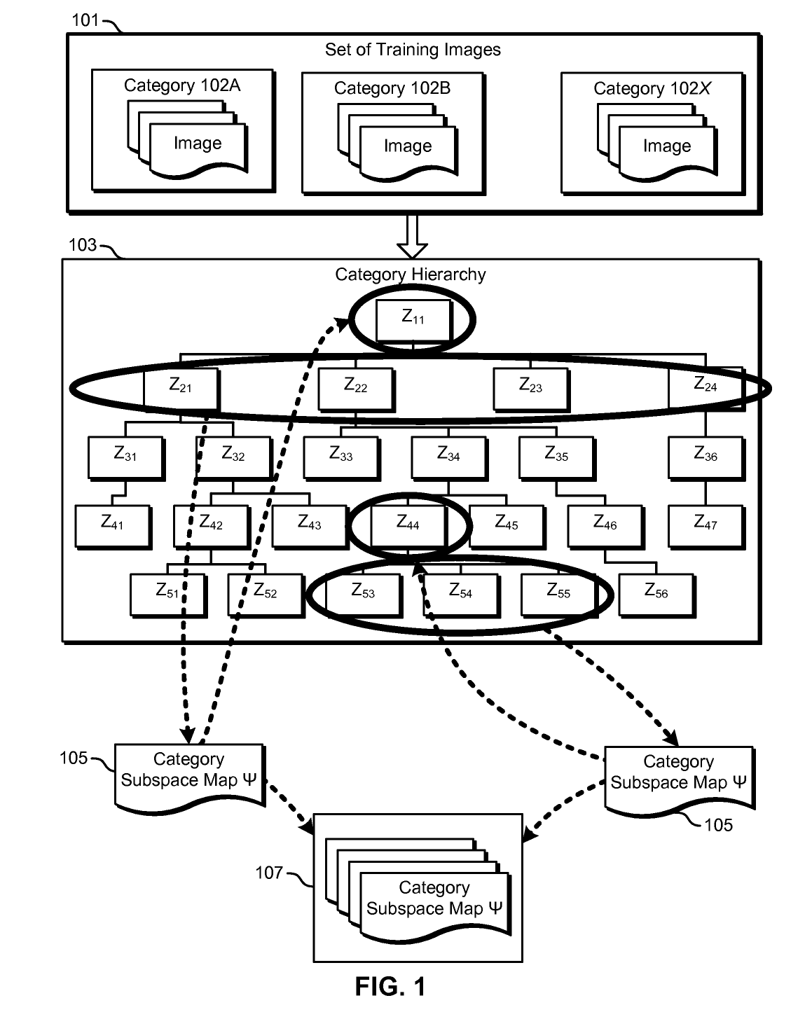

FIG. 1 illustrates an example embodiment of the generation of hierarchical subspace maps. A set of training images 101 (“training set”) includes image categories 102 (categories 102A to 102X in this example). Each category 102 is associated with one or more images. The categories are organized into a category hierarchy 103. In some embodiments, every node Z in the category hierarchy 103 is a category 102 found in the training set 101, and in some embodiments, not every node Z in the category hierarchy 103 is a category 102 found in the training set 101.

Category subspace maps Ψ 105 are then generated for each node Z in the category hierarchy 103. For a particular node Zᵢ, a category subspace map Ψ 105 is generated based on the images associated with the child nodes of the particular node Zᵢ. Thus, in some embodiments, a respective category subspace map Ψ 105 is generated for each parent node Z (i.e., parent category) in the category hierarchy 103 based on the child nodes (i.e., child categories) of the parent node Z. The category subspace maps Ψ 105 are then added to a collection of category subspace maps 107. In some embodiments a category subspace map Ψ 105 maps a D-dimensional vector to a lower-dimensional vector.

In some embodiments, generating a category subspace map Ψ 105 includes generating a compressed matrix for each node Z, where the compressed matrix has c×c dimensions, and where c is the number of child nodes of the node Z. Thus, for node Z₁₁, which has four child nodes, the compressed matrix is a 4×4 dimensional matrix and is generated based on the respective images associated with the four child nodes. Also, for node Z₄₄, which has three child nodes, the compressed matrix is a 3×3 dimensional matrix and is generated based on the respective images that are associated with the three child nodes. Then the c−1 most significant eigenvectors are calculated for each of the compressed matrices. For example, for the 4×4 compressed matrix, the three most significant eigenvectors are calculated and are used to generate the category subspace map Ψ 105.

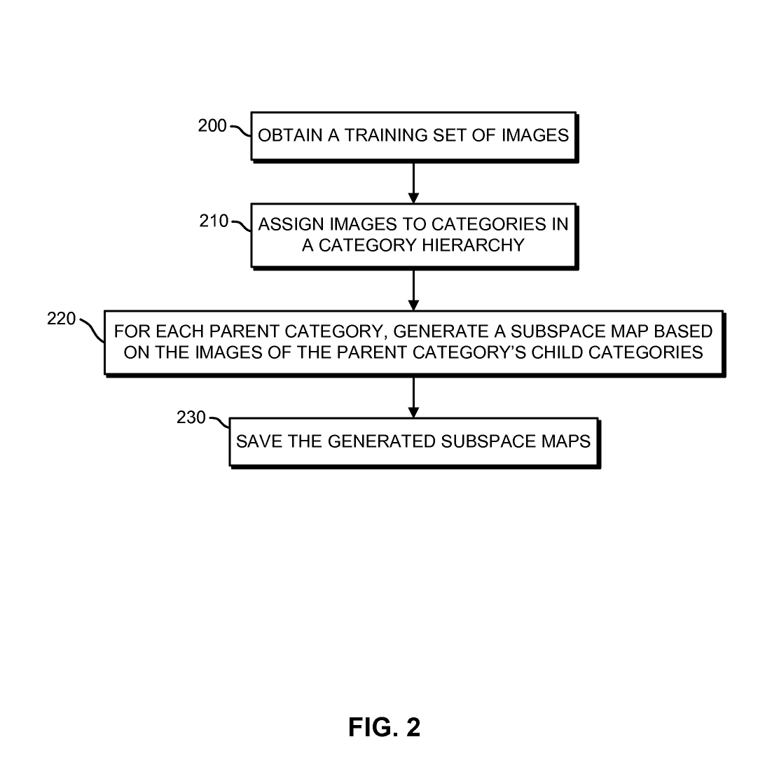

FIG. 2 illustrates an example embodiment of a method for generating hierarchical subspace maps. The blocks of this method and the other methods described herein may be performed by one or more computing devices, for example the systems and devices described herein. Also, although this method and the other methods described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this method and the other methods described herein may omit blocks, add blocks, change the order of the blocks, combine blocks, or divide blocks into more blocks.

The method of FIG. 2 starts in block 200, where a training set of images is obtained. Next, in block 210, the images are assigned to categories in a hierarchy of categories, for example according to the respective category labels that are associated with the images. The flow then moves to block 220, where, for each parent category in the hierarchy, a subspace map Ψ is generated based on the images of the parent category's child categories. Finally, in block 230, the generated subspace maps Ψ are saved on one or more computer-readable media.

To generate the subspace maps Ψ in block 220, some embodiments use linear-discriminant analysis (LDA) or regularized linear-discriminant analysis (R-LDA). LDA is a class-specific technique that uses supervised learning to find a subspace map Ψ of L feature bases, denoted as Ψ=[ψ₁, . . . , ψ_{L}], by maximizing the Fisher's discriminant criterion, which is generally expressed as the ratio of the between- and within-class scatters of training samples (e.g., images). R-LDA attempts to generate a subspace map Ψ by optimizing a regularized version of the Fisher's discriminant criterion:

$$Ψ = {arg max}_{Ψ} \frac{\vert {Ψ}^{T} {S}_{b} Ψ \vert}{\vert η ( {Ψ}^{T} {S}_{b} Ψ ) + ( 1 - η ) ( {Ψ}^{T} {S}_{w} Ψ ) \vert} , \qquad ( 1 )$$

where ηε[0,1] is a regularization parameter, where S_{b} is a between-class scatter matrix, and where S_{w} is a within-class scatter matrix. The between-class scatter matrix S_{b} and the within-class scatter matrix S_{w} may be calculated according to the following expressions:

$$\begin{matrix}\begin{matrix}{S}_{b} = \frac{1}{N} {\sum }_{i = 1}^{c} {C}_{i} ( {\overline{z}}_{i} - \overline{z} ) {( {\overline{z}}_{i} - \overline{z} )}^{T} \\ = {\sum }_{i = 1}^{c} {Φ}_{b , i} {Φ}_{b , i}^{T} \\ = {Φ}_{b} {Φ}_{b}^{T} , and\end{matrix} & ( 2 ) \\ {S}_{w} = \frac{1}{N} {\sum }_{i = 1}^{c} {\sum }_{j = 1}^{{c}_{i}} ( {z}_{ij} - {\overline{z}}_{i} ) {( {z}_{ij} - {\overline{z}}_{i} )}^{T} , & ( 3 )\end{matrix}$$

where Cᵢ is the number of samples (e.g., images) in the i-th class, zᵢⱼ is the j-th sample (e.g., an image representation in the form of a vector generated at least in part from one or more image features) of the i-th class, z̅ᵢ is the mean of the i-th class, z̅ is the mean of the entire training set,

$${Φ}_{b , i} = \sqrt{\frac{{c}_{i}}{N}} ( {\overline{z}}_{i} - \overline{z} ) ,$$

and Φ_{b}=[Φ_{b,1}, . . . , Φ_{b,C}].
In some embodiments, zᵢⱼ is a global image feature, such as a Fisher vector, for image j of class i and is generated from a Gaussian mixture model estimated from the SIFT descriptors of all images in the collections of all images in all classes. In other embodiments, zᵢⱼ may be a dense sift feature vector for image j of class i. In fact, there are many forms that zᵢⱼ may take, whereby zᵢⱼ provides a representation of image j of class i.

Also, the dimensionality of Φ_{b} is D×C, the dimensionality of the between-class scatter matrix Φ_{b}Φ_{b} is D×D, and D is the dimensionality of the samples (image representations) zᵢⱼ. When the dimensionality of the samples (image representations) zᵢⱼ is high, traditional LDA first applies a PCA operation to reduce the dimensionality of the samples, and then solves a standard LDA problem in the lower-dimensional PCA subspace. But in some cases the dimensionality of the samples (image representations) zᵢⱼ is too high to effectively perform PCA, for example when the Fisher-vector representation is a 128,000-dimensional representation. However, R-LDA finds the m (m≦C−1) eigenvectors of a compressed matrix Φ_{b}^{T}Φ_{b}, which is a matrix of size C×C. The following operations may be performed to generate a subspace map Ψ in block 220:

1) C is set to the number of child categories (child nodes) of the parent category (parent node) for which a subspace map Ψ is being generated. For example, for parent category Z₄₄, which has three child categories, C=3. 2) The within-class scatter matrix S, is generated using the image representations (samples) that are associated with the child categories. 3) A compressed matrix Φ_{b}^{T}Φ_{b} is generated, and the matrix Φ_{b} is related to the between-class scatter matrix Φ_{b}Φ_{b}^{T}. 4) The m (m≦C−1) eigenvectors of the compressed matrix Φ_{b}^{T}Φ_{b} that have non-zero eigenvalues, Eₘ=[e₁, . . . , eₘ], are calculated. 5) The first m most significant eigenvectors Uₘ of the between-class scatter matrix Φ_{b}Φ_{b}^{T} and their corresponding eigenvalues Λₘ are calculated based on the m eigenvectors Eₘ of the compressed matrix Φ_{b}^{T}Φ_{b}, for example according to Uₘ=Φ_{b}Eₘ and Λₘ=Uₘ^{T}S_{b}Uₘ. 6) Then the eigenvectors Uₘ and the eigenvalues Λₘ of the between-class scatter matrix Φ_{b}Φ_{b}^{T} are factored to generate a transformation, for example to generate a between-class-scatter subspace transformation H according to H=UₘΛₘ^{-1/2}. 7) The within-class scatter matrix S_{w} is transformed into the space defined by the eigenvectors Uₘ of the between-class scatter matrix Φ_{b}Φ_{b}^{T}, for example by using the between-class-scatter subspace transformation H according to H^{T}S_{w}H, and the eigenvectors P=[p₁, . . . , pₘ] of H^{T}S_{w}H are calculated and sorted in an increasing eigenvalue order. 8) The eigenvectors corresponding to the lowest M (M≦m) eigenvalues in P are selected. P_{M} and Λ_{w} respectively denote the selected eigenvectors and their corresponding eigenvalues. 9) The R-LDA subspace map Ψ is generated based on the selected eigenvectors P_{M} and their respective eigenvalues Λ_{w}, for example according to Ψ=HP_{M}(ηI+(1−η)^{-1/2}.

It should be appreciated that the eigenvalues in this document (e.g., denoted as Λₘ or Λ) are typically represented in diagonal-matrix form, and the set of corresponding eigenvectors are often represented as columns of a matrix where the i-th column contains the eigenvector corresponding to the i-th diagonal element of the eigenvalue matrix.

Given an input image representation z (input sample z), its R-LDA-mapped image representation v for a specific subspace map Ψ may be obtained by a linear projection according to

v=Ψ^{T}z, (4)

where image representation v is an m-dimensional vector and where the subspace map Ψ effectively maps the input sample (image representation) z from dimensionality D to a lower dimensionality m (m≦C−1).

Also, a weight ω may be assigned to each subspace map Ψ. Thus, given an input sample (image representation) z, its corresponding HR-LDA-based image representation V can be obtained by concatenating its projections vᵢⱼ^{T} on each R-LDA subspace map Ψ, for example according to

V=[ω₂₁·v₂₁^{T}, . . . ,ωₗⱼ·vₗⱼ^{T}, . . . ]^{T}, (5)

where image representation vₗⱼ=Ψₗⱼ^{T}z, and where ωₗⱼ is a weight that indicates the significance of a corresponding subspace map Ψₗⱼ. Some embodiments set the weight according to the number of training samples included in the category Zₗⱼ that was used to generate the corresponding subspace map Tₗⱼ. It may reflect the principle that higher-level misclassification should cost more than lower-level misclassification. For example, a misclassification of mammal as bird is more acceptable than a misclassification of mammal as plant.

Additionally, some embodiments do not estimate weights. For example, some embodiments consider only the between-class scatters in the hierarchical structure. Some embodiments that consider only the between-class scatters in the hierarchical structure produce the between-class scatter subspace transformation Hₗ₊₁ⱼ. Each training sample z is projected into all the between-class scatter subspaces using the transformations Hₗ₊₁ⱼ to generate projections bₗⱼ, for example according to

bₗⱼ=HTₗⱼ^{T}z. (6)

Some embodiments take only the first m most significant elements in a projection bₗⱼ in order to further reduce dimensionality. A corresponding image representation b for the sample (image representation) z can be obtained by concatenating all the projections bₗⱼ into the between-class scatter subspaces HTₗⱼ^{T}z, for example according to

b=[b₂₁^{T}, . . . ,bₗⱼ^{T}, . . . ]^{T}. (7)

Also, some embodiments compute the within-class scatter matrix of all the categories by replacing each training sample (image representation) z with its corresponding representation b in equation (3). These embodiments then find the eigenvectors P=[p₁, . . . , pₙ] of the within-class scatter matrix S_{w} sorted in an increasing eigenvalue order. Let P_{M} and Λ_{w} be the first M most significant of the eigenvectors P and their corresponding eigenvalues Λ written in diagonal matrix form, respectively. The embodiments generate the final subspace map Ψ according to Ψ=P_{M}(ηI+(1−η)^{-1/2}.

Also, given an input sample (image representation) z, in some embodiments its corresponding representation v (e.g., HR-LDA-based representation) can be obtained by performing the following: i) generating a representation b using equation (7), and ii) projecting the representation b to the subspace map Ψ according to

v=Ψ^{T}b. (8)

Thus, in some embodiments, to generate a subspace map Ψ for a parent node Z that has c child nodes, a compressed matrix Φ_{b}^{T}Φ_{b}, which is a matrix of size c×c, is generated; the m (m≦c−1) eigenvectors Eₘ of the compressed matrix Φ_{b}^{T}Φ_{b} are calculated; the eigenvectors Eₘ of the compressed matrix Φ_{b}^{T}Φ_{b} are transformed to the space of the between-class scatter matrix Φ_{b}Φ_{b}^{T} to find the eigenvectors Uₘ of the between-class scatter matrix Φ_{b}Φ_{b}^{T}; the eigenvalues Λₘ of the between-class scatter matrix Φ_{b}Φ_{b}^{T} are calculated using the eigenvectors Uₘ; the within-class scatter matrix S, is incorporated into the space defined by the eigenvectors Uₘ of the between-class scatter matrix Φ_{b}Φ_{b}^{T} that have non-zero eigenvalues; the eigenvectors P of the within-class scatter matrix S_{w} in the space defined by the eigenvectors Uₘ of the between-class scatter matrix Φ_{b}Φ_{b}^{T} that have non-zero eigenvalues, as well as the eigenvalues Λ_{w} (e.g., in diagonal matrix form) of the eigenvectors P, are calculated; and the eigenvectors P of the within-class scatter matrix S_{w} in the space defined by the eigenvectors Uₘ of the between-class scatter matrix Φ_{b}Φ_{b}^{T} are used to define a subspace map Ψ for the parent node Z. The eigenvectors P that are used to define the subspace map Ψ for the parent node Z may be selected to maximize between-class scatter, minimize within-class scatter, or maximize the ratio of between-class scatter to within-class scatter.

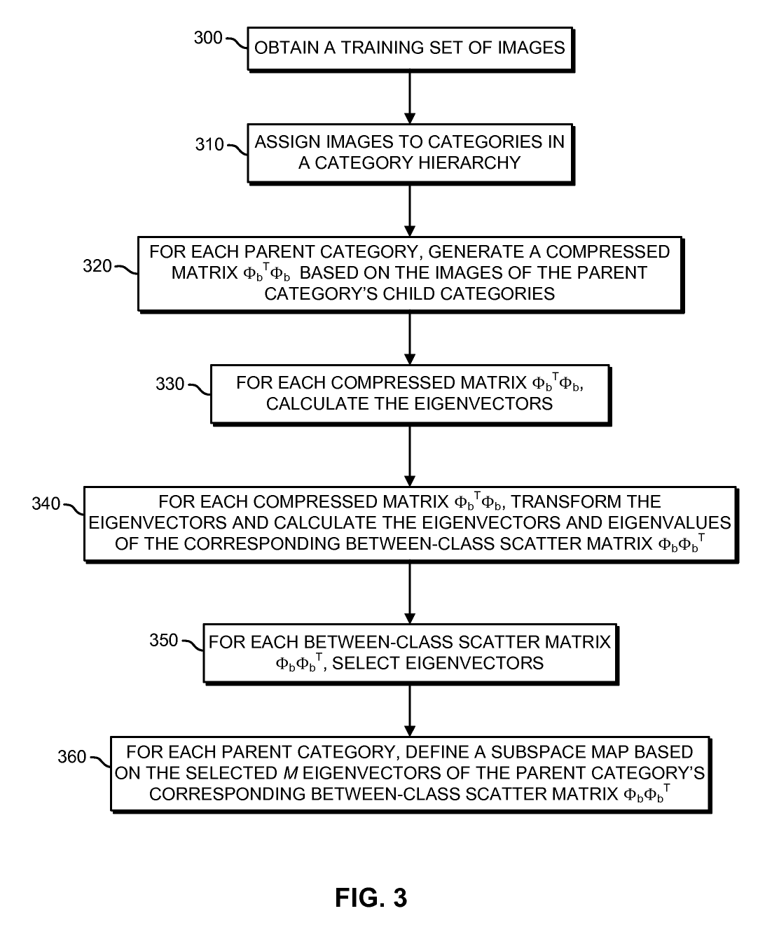

FIG. 3 illustrates an example embodiment of a method for generating hierarchical subspace maps Ψ. The flow starts in block 300, where a training set of images is obtained. Next, in block 310, the images in the training set are assigned to categories in a category hierarchy. The flow then moves to block 320 where, for each parent category, a compressed matrix Φ_{b}^{T}Φ_{b} is generated based on the respective image representations of the parent category's child categories. Following, in block 330, the eigenvectors Eₘ are calculated for each compressed matrix Φ_{b}^{T}Φ_{b}.

The flow then moves to block 340, where the eigenvectors Eₘ of each of the compressed matrices Φ_{b}^{T}Φ_{b} are transformed to the spaces of the respective between-class scatter matrices Φ_{b}Φ_{b}^{T}, and the respective eigenvectors Uₘ and the eigenvalues Λₘ of the between-class scatter matrices Φ_{b}Φ_{b}^{T} are calculated. Next, in block 350, for each between-class scatter matrix Φ_{b}Φ_{b}^{T}, M eigenvectors are selected, for example to maximize between-class scatter, minimize within-class scatter, or maximize the ratio of between-class scatter to within-class scatter. The operations in block 350 may include incorporating the within-class scatter matrix S_{w} into the space defined by the eigenvectors Uₘ and the eigenvalues Λₘ of the between-class scatter matrices Φ_{b}Φ_{b}^{T}. Thus, the selected M eigenvectors may not be the eigenvectors Uₘ of the between-class scatter matrices Φ_{b}Φ_{b}^{T}, but may be other eigenvectors (e.g., the eigenvectors P that incorporate information from the within-class scatter matrix S_{w}). Finally, in block 360, for each parent category, a subspace map Ψ is defined based on the selected M eigenvectors.

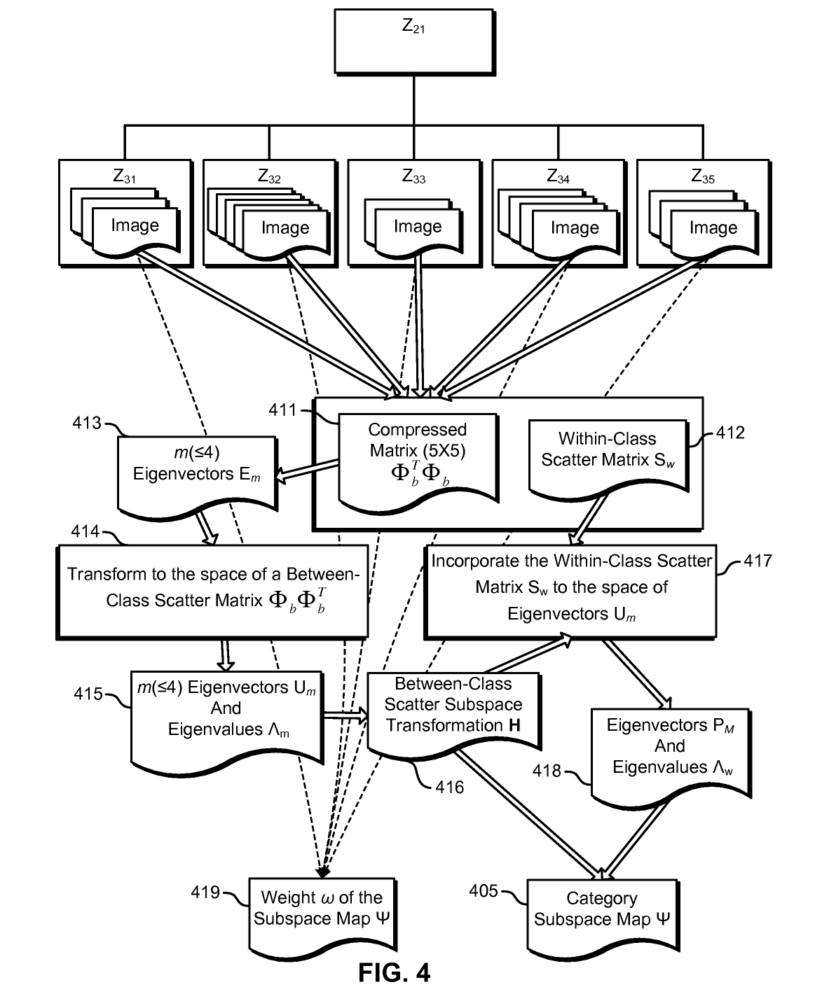

FIG. 4 illustrates an example embodiment of a flow of operations for generating a subspace map Ψ for a category Z. Category Z₂₁ has five child categories Z₃₁ to Z₃₅, each of which is associated with a respective set of images. To generate a subspace map Ψ for category Z₂₁, the image representations of its child categories Z₃₁ to Z₃₅ are used as samples zᵢⱼ to construct a compressed matrix Φ_{b}^{T}Φ_{b} 411 and a within-class scatter matrix S_{w} 412. Because category Z₂₁ has five child categories Z₃₁ to Z₃₅, the compressed matrix Φ_{b}^{T}Φ_{b} 411 is a 5×5 dimensional matrix.

Next, m eigenvectors Eₘ 413 are calculated for and selected for the compressed matrix Φ_{b}^{T}Φ_{b} 411. Because the compressed matrix Φ_{b}^{T}Φ_{b} 411 is a 5×5 dimensional matrix, in some embodiments m is selected to be fewer than 5 (i.e., m≦4). The eigenvectors Eₘ 413 are then transformed in block 414 to the space of a between-class scatter matrix Φ_{b}Φ_{b}^{T} to generate the first m most significant eigenvectors Uₘ 415 of the between-class scatter matrix Φ_{b}Φ_{b}^{T} and their corresponding eigenvalues Λₘ, for example according to Uₘ=Φ_{b}Eₘ and Λₘ=Uₘ^{T}S_{b}Uₘ. Then a between-class-scatter-subspace transformation H 416 is generated based on the first m most significant eigenvectors Uₘ 415 of the between-class scatter matrix φ_{b}^{T}Φ_{b} and their corresponding eigenvalues Λₘ, for example according to H=UₘΛₘ^{-1/2}.

Next, in block 417, the between-class-scatter-subspace transformation H 416 and the within-class scatter matrix S_{w} 412 are used to incorporate the within-class scatter matrix S_{w} 412 into the space defined by the eigenvectors Uₘ 415 and generate M eigenvectors P_{M} and their corresponding eigenvalues Λ_{w} 418. The number of M eigenvectors P_{M} 418 may be less than or equal to the number of m eigenvectors Eₘ 413 for the compressed matrix Φ_{b}^{T}Φ_{b} 411 (M≦m). A category subspace map Ψ 405 for the category Z₂₁ is then generated based on the between-class-scatter-subspace transformation H 416 and the eigenvectors P_{M} 418 and their corresponding eigenvalues Λ_{w}, for example according to Ψ=HP_{M}(ηI+(1−η)^{-1/2}. Also, a weight ψ 419 may be calculated for the subspace map Ψ, for example based on the number of images associated with the child categories Z₃₁ to Z₃₅ of the category Z₂₁ or based on the number of child categories of the category Z₂₁.

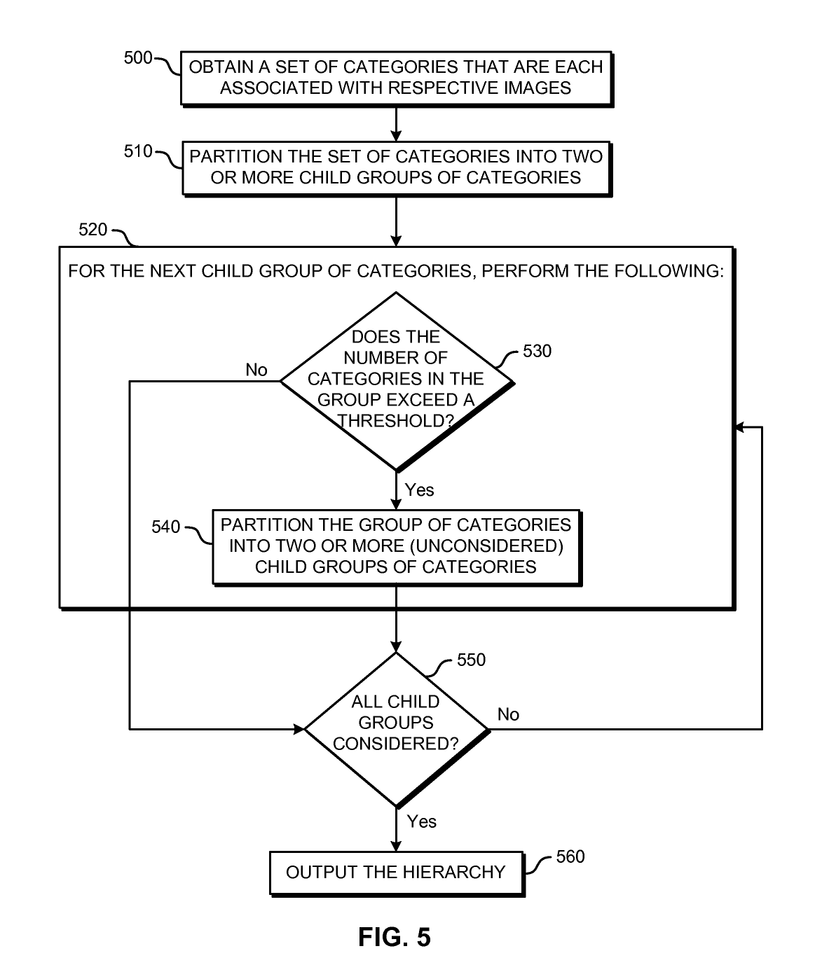

FIG. 5 illustrates an example embodiment of a method for generating a category hierarchy. The flow starts in block 500, where a set of categories, each of which is associated with respective images, is obtained. Next, in block 510, the set of categories is partitioned into two or more unconsidered child groups of categories. Some embodiments use k-means clustering that is based on a semantic distance, which considers the similarity of the categories based on a category hierarchy (e.g., WordNet). Given two category labels, Lₓ and L_{y}, the semantic distance dₛ (Lₓ, L_{y}) between them may be defined according to

dₛ(Lₓ,L_{y})=hc(Lₓ,L_{y}), (9)

where hc(Lₓ, L_{y}) is the hierarchical classification cost, and it may be equal to the height of the lowest common ancestor of Lₓ and L_{y} in the category hierarchy, divided by the maximum possible height. As a result, for example, the definition of equation (9) may make the distance between bears and dogs closer than the distance between apples and dogs.

Some embodiments use k-means clustering based on a sample distance, which considers the similarity of the samples that belong to each category. Let (μₓ, Σₓ) and (μ_{y}m Σ_{y}) be the sample mean and covariance of the categories Lₓ and L_{y}, respectively. In some embodiments the sample distance is the Mahalanobis distance,

$${d}_{m} ( {L}_{x} , {L}_{y} ) = \frac{1}{2} {( {μ}_{x} - {μ}_{y} )}^{T} {( {Σ}_{x} + {Σ}_{y} )}^{- 1} ( {μ}_{x} - {μ}_{y} ) . \qquad ( 10 )$$

If Σₓ=Σ_{y}=I, then the Mahalanobis distance is equivalent to the Euclidean distance dₑ(Lₓ, L_{y})=∥μₓ−μ_{y}∥. Also, some embodiments use the Kullback-Leibler (KL) divergence distance and the Bhattycharya distance. In addition, clustering can be performed in an augmented space using a sample space and a category label space.

The flow then moves to block 520, where, for the next group of unconsidered child categories, the operations in block 530 and 540 are performed. In block 530, it is determined if the number of categories in the child group exceeds a threshold. If yes, then the flow moves to block 540, where the child group of categories is partitioned into two or more child groups of categories, which are designated as children of the child group of categories considered in block 530. For example, if the number of categories in child group “A” is determined to exceed the threshold in block 530, then child group “A” is partitioned into child groups “B” and “C” in block 540, and child groups “B” and “C” are designated as children of child group “A”. Also, these two or more child groups are identified as unconsidered by block 550.

If in block 530 it is determined that the number of categories in the child group does not exceed a threshold, or after block 540 is performed, then the flow moves to block 550. In block 550 it is determined if all child groups have been considered. If not, then the flow returns to block 520, where the next child group is considered. If yes, then the flow proceeds to block 560, where the hierarchy is output or saved to a computer-readable medium.

In some embodiments, every category in the set of categories is designated as a child category but not a parent category. Thus, every category in the set of categories is a node in the lowest level of the hierarchy. Also, categories that are not in the original set of categories may be added to the hierarchy, for example in blocks 510 or 540. Thus, if the original categories include dog, cat, bird, whale, rodent, bush, tree, vine, grass, and moss, the new categories animal and plant may be added to the hierarchy during the generation of the hierarchy.

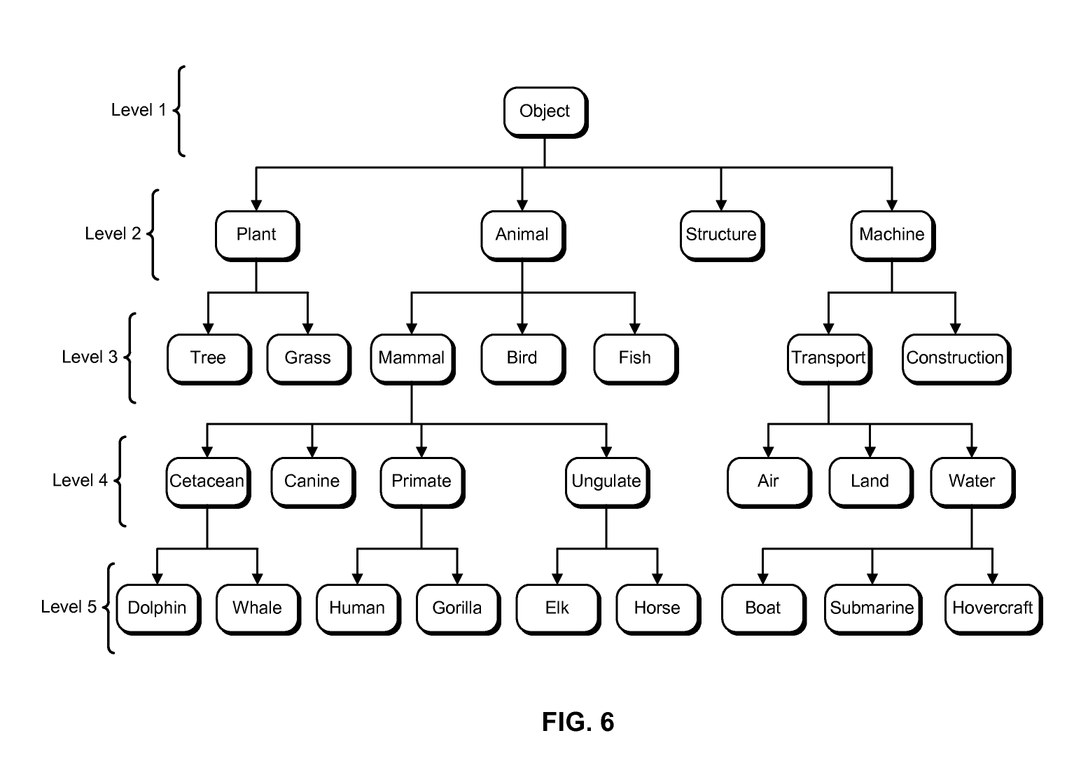

FIG. 6 illustrates an example embodiment of a category hierarchy. The category in level 1 is a parent category but not a child category. The categories in levels 2-4 are both parent categories and child categories. Finally, the categories in level 5 are child categories but not parent categories.

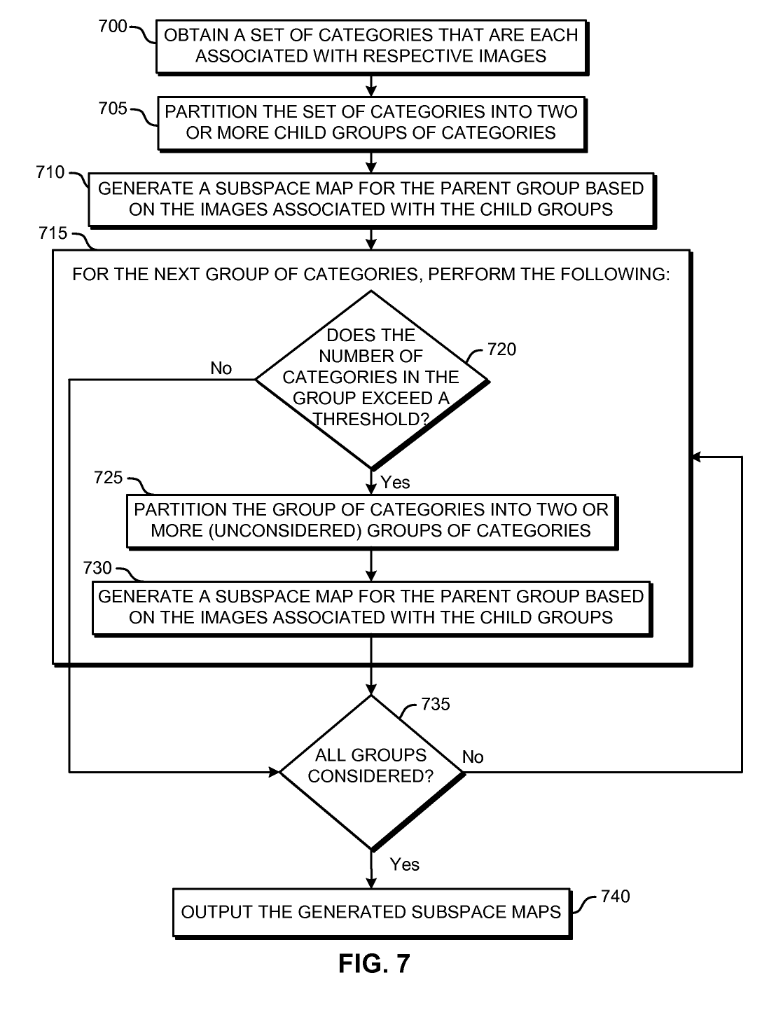

FIG. 7 illustrates an example embodiment of a method for generating hierarchical subspace maps W. The flow starts in block 700, where a set of categories Z₁={Z₁ⱼ}ⱼ₌₁^{K}^{₁}, each of which is associated with respective images, is obtained. Also, a counter l is set to one (l=1), and a threshold Kₘᵢₙ is set. Kₘᵢₙ defines the minimal number of categories required to perform a partition. Next, in block 705, the set of categories is partitioned into two or more groups of child categories of a parent category, and the parent category may be either a new category or a category that is already included in the set of categories. Thus, the set Zₗ is partitioned into Kₗ₊₁ child groups {Zₗ₊₁ⱼ}ⱼ₌₁^{K}^{ₗ₊₁}, with each one containing at least two categories of Zₗ. The flow then moves to block 710, where a subspace map Ψₗ is generated for the parent group using the Kₗ₊₁ child groups {Zₗ₊₁ⱼ}ⱼ₌₁^{K}^{ₗ₊₁}, for example according to FIG. 4. Also, the Kₗ₊₁ child groups are designated as Zₗ₊₁ groups of categories, for example according to Zₗ₊₁={Zₗ₊₁ⱼ}ⱼ₌₁^{K}^{ₗ₊₁}; all the child categories of Zₗ₊₁ⱼ are relabeled with the same label as Zₗ₊₁ⱼ; and the counter 1 is incremented (l=l+1).

Next, at least some of the operations in block 715 are performed for the next group of categories. In block 720, it is determined if the number of categories Kₗ in the group Zₗ exceeds a threshold Kₘᵢₙ: Kₗ>Kₘᵢₙ. If not, then the flow proceeds to block 735. If yes, then the flow proceeds to block 725, where the group Zₗ is partitioned into Kₗ₊₁ child groups {Z_{l+1j}}_{ⱼ₌₁}^{K}^{ₗ₊₁}, each of which contains at least one category of Zₗ. The flow then moves to block 730, where a subspace map Ψₗ is generated for the parent group using the Kₗ₊₁ child groups {Zₗ₊₁ⱼ}ⱼ₌₁^{K}^{ₗ₊₁}, for example according to FIG. 4. Also, the Kₗ₊₁ child groups are designated as Zₗ₊₁ groups of categories, for example according to Zₗ₊₁={Zₗ₊₁ⱼ}ⱼ₌₁^{K}^{ₗ₊₁}; all the child categories of Zₗ₊₁ⱼ are relabeled with the same label as Zₗ₊₁ⱼ; and the counter l is incremented (l=l+1). The flow then moves to block 735.

In block 735 it is determined if all of the groups have been considered. If not, the flow returns to block 715. If yes, then the flow moves to block 740, where the generated subspace maps {Ψₗⱼ}_{l,j}, are output.

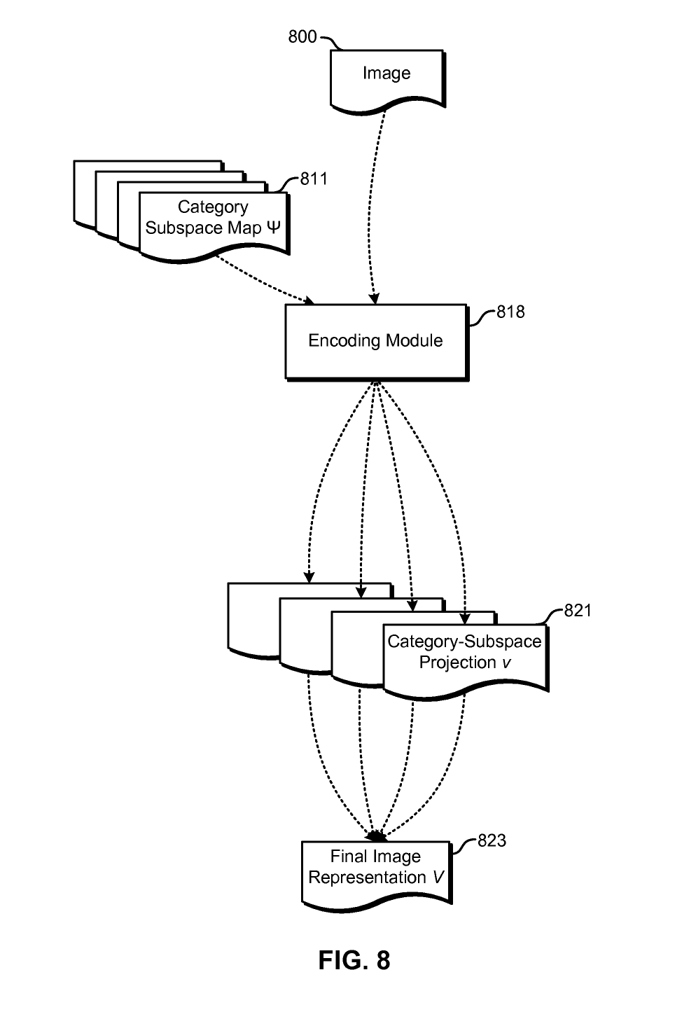

FIG. 8 illustrates an embodiment of the encoding of an image 800 based on category subspace maps Ψ 811. The image 800 is obtained by an encoding module 818. Modules include logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the system includes additional or fewer modules, the modules are combined into fewer modules, or the modules are divided into more modules. Though the computing device or computing devices that execute the software instructions in a module perform the operations, for purposes of description a module may be described as performing one or more operations.

The encoding module 818 generates an initial representation z of the image 800 (e.g., using feature extraction to generate a Fisher vector, a bag-of-visual words) and calculates the projections of the representation z of the image 800 based on each of the category subspace maps Ψ 811 to generate category-subspace projections v 821, for example according to equation (4) or equation (8). Then a final image representation V 823 is generated based on the category-subspace projections v 821, for example according to equation (5).

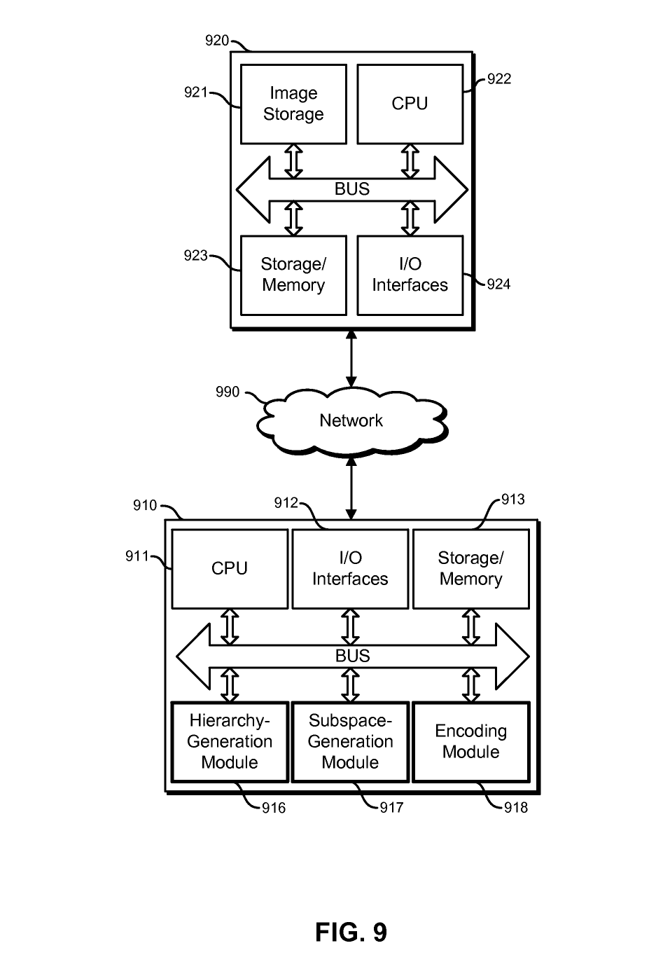

FIG. 9 illustrates an example embodiment of a system for generating subspace maps. The system includes a representation-generation device 910 and an image-storage device 920. The representation-generation device 910 includes one or more processors (CPU) 911, I/O interfaces 912, and storage/memory 913. The CPU 911 includes one or more central processing units, which include microprocessors (e.g., a single core microprocessor, a multi-core microprocessor) or other circuits, and is configured to read and perform computer-executable instructions, such as instructions stored in storage or in memory (e.g., software in modules that are stored in storage or memory). The computer-executable instructions may include those for the performance of the operations described herein. The I/O interfaces 912 include communication interfaces to input and output devices, which may include a keyboard, a display, a mouse, a printing device, a touch screen, a light pen, an optical-storage device, a scanner, a microphone, a camera, a drive, and a network (either wired or wireless).

The storage/memory 913 includes one or more computer-readable or computer-writable storage media. A computer-readable storage medium does not include transitory, propagating signals and is a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage/memory 913 is configured to store computer-readable data or computer-executable instructions. The components of the representation-generation device 910 communicate via a bus.

The representation-generation device 910 also includes a hierarchy-generation module 916, a subspace-generation module 917, and an encoding module 918. In some embodiments, the representation-generation device 910 includes additional or fewer modules, the modules are combined into fewer modules, or the modules are divided into more modules. The hierarchy-generation module 916 contains instructions that, when executed, or circuits that, when activated, cause the representation-generation device 910 to obtain a training set of categories and associated images and generate a category hierarchy based in the obtained training set. The subspace-generation module 917 contains instructions that, when executed, or circuits that, when activated, cause the representation-generation device 910 to obtain a training set of categories and associated images, obtain a category hierarchy, and generate respective subspace maps based on the categories. The encoding module 918 contains instructions that, when executed, or circuits that, when activated, cause the representation-generation device 910 to obtain an image representation and encode the image representation based on category subspace maps.

The image-storage device 920 includes a CPU 922, storage/memory 923, I/O interfaces 924, and image storage 921. The image storage 921 includes one or more computer-readable media that are configured to store images. The image-storage device 920 and the representation-generation device 910 communicate via a network 990. In some embodiments, the image storage device may not store the original images, but instead may store representations of the images.

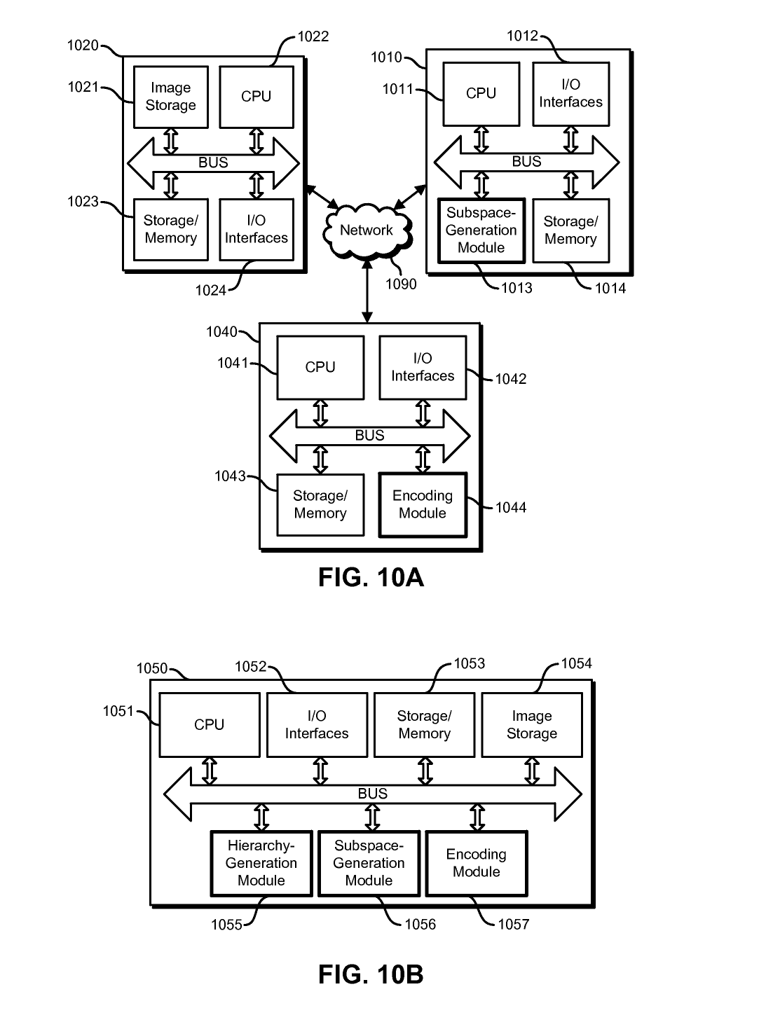

FIG. 10A illustrates an example embodiment of a system for generating subspace maps. The system includes an image-storage device 1020, a subspace-generation device 1010, and a representation-generation device 1040, which communicate via a network 1090. The image-storage device 1020 includes one or more CPUs 1022, I/O interfaces 1024, storage/memory 1023, and image storage 1021. The subspace-generation device 1010 includes one or more CPUs 1011, I/O interfaces 1012, storage/memory 1014, and a subspace-generation module 1013, which is a combination of the hierarchy-generation module 916 and subspace-generation module 917 in FIG. 9. The representation-generation device 1040 includes one or more CPUs 1041, I/O interfaces 1042, storage/memory 1043, and an encoding module 1044.

FIG. 10B illustrates an example embodiment of a system for generating subspace maps. The system includes a representation-generation device 1050. The representation-generation device 1050 includes one or more CPUs 1051, I/O interfaces 1052, storage/memory 1053, an image-storage module 1054, a hierarchy-generation module 1055, a subspace-generation module 1056, and an encoding module 1057. Thus, in this example embodiment of the subspace-generation device 1050, a single device performs all the operations and stores all the applicable information.

The above-described devices, systems, and methods can be implemented by providing one or more computer-readable media that contain computer-executable instructions for realizing the above-described operations to one or more computing devices that are configured to read and execute the computer-executable instructions. Thus, the systems or devices perform the operations of the above-described embodiments when executing the computer-executable instructions. Also, an operating system on the one or more systems or devices may implement at least some of the operations of the above-described embodiments. Therefore, the computer-executable instructions or the one or more computer-readable media that contain the computer-executable instructions constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A method comprising:
obtaining a training set of images, wherein the images in the training set of images are each associated with at least one category in a plurality of categories;
organizing the images in the training set of images into a category hierarchy based on the training set of images and on the plurality of categories, wherein the category hierarchy identifies each of the categories in the plurality of categories as at least one of a parent category and child category; and
generating a subspace map for each parent category based on images associated with respective child categories of the parent category, thereby generating a plurality of subspace maps.

2. The method of claim 1, wherein the subspace maps are LDA subspace maps.

3. The method of claim 2, wherein the subspace maps are regularized LDA subspace maps.

4. The method of claim 1, wherein generating the category hierarchy is further based on semantic distances between the categories.

5. The method of claim 1, wherein some categories in the category hierarchy are both child categories and parent categories.

6. The method of claim 1, wherein generating the subspace map for a parent category includes calculating one or more most-significant eigenvectors in a space defined by representations of image features of the images that are associated with child categories of the parent category.

7. The method of claim 4, wherein generating the category hierarchy is further based on a threshold, and wherein a group of categories is divided into at least two parent categories and two groups of child categories when a number of categories in the group of categories exceeds the threshold.

8. The method of claim 1, further comprising weighting each subspace map.

9. The method of claim 8, wherein the weighting of each subspace map is based on a number of images associated with the respective category that corresponds to the subspace map.

10. The method of claim 8, wherein the weighting of each subspace map is based at least in part on the number of child categories of the parent category.

11. The method of claim 1, further comprising projecting a query image representation with each of the subspace maps, thereby producing a plurality of projections of the query image representation.

12. A computing device comprising:
one or more computer-readable media; and
one or more processors coupled to the computer-readable media and configured to cause the computing device to perform operations including
obtaining a training set of images;
assigning the images to a category in a category hierarchy, wherein the category hierarchy identifies each of the categories in the plurality of categories as at least one of a parent category and child category; and
generating a subspace map for each parent category based on images assigned to respective child categories of the parent category, thereby generating a plurality of subspace maps.

13. The computing device of claim 12, wherein the one or more processors are further configured to cause the computing device to assign a respective weight to each subspace map.

14. The computing device of claim 12, wherein the one or more processor are further configured to cause the computing device to project an input image representation with each of the subspace maps, thereby generating a plurality of subspace projections.

15. The computing device of claim 14, wherein the one or more processor are further configured to cause the computing device to generate a representation of the input image based on the plurality of subspace projections.

16. One or more computer-readable media storing instructions that, when executed by one or more computing devices, cause the computer devices to perform operations comprising:
obtaining a training set of images;
assigning the images to a category in a category hierarchy, wherein the category hierarchy identifies each of the categories in the plurality of categories as at least one of a parent category and child category; and
generating a subspace map for each parent category based on images assigned to respective child categories of the parent category, thereby generating a plurality of subspace maps.

17. The one or more computer-readable media of claim 16, wherein generating the subspace map for each parent category is based on a scatter matrix that is defined by image representations of the images that are associated with the respective child categories of the parent category.

18. The one or more computer-readable media of claim 17, wherein generating the subspace map for each parent category includes calculating eigenvectors based on the scatter matrices.
